(19) United States
(12) Patent Application Publication
(10) Pub. No.: US 2022/0371690 A1
(43) Pub. Date: Nov. 24, 2022

(54) UNDERWATER PORT-HOLE WHOSE SURFACE ORIENTED TOWARD THE INSIDE OF ITS MOUNTING STRUCTURE IS FACETED

(71) Applicant: SAINT-GOBAIN GLASS FRANCE, COURBEVOIE (FR)

(72) Inventors: Jean-Benoît MAYEUX, SAINT JEAN DE BRAYE (FR); Thomas TONDU, SAINT-MARTIN D'ABBAT (FR)

(21) Appl. No.: 17/770,933

(22) PCT Filed: Oct. 19, 2020
(86) PCT No.: PCT/EP2020/079317

§ 371 Date: Apr. 21, 2022

(30) Foreign Application Priority Data
Oct. 22, 2019 (FR) FR1911804

(51) Int. Cl. B63B 19/00; B32B 7/12; B32B 17/10; B32B 27/30; B32B 27/36; B32B 27/40

(52) U.S. Cl. CPC B63B 19/00; B32B 7/12; B32B 17/10; B32B 27/308; B32B 27/365; B32B 27/40; B63B 2019/0038; B32B 2250/42; B32B 2551/00

(57) ABSTRACT

A port-hole of an immersed structure, for seeing, from inside the structure in air, to the outside of the structure in water, level with the structure, wherein the face of the port-hole oriented toward the inside of the structure includes at least one flat section forming an angle of 20 to 40° with respect to the face of the port-hole oriented toward the outside of the structure.

The invention relates to the field of port-holes of ships, submarines or any aquatic equipment such as an oil platform with an immersed outer face and an inner face in air having a field of view allowing observation of elements close to the structure (hull of the ship, wall of the immersed equipment). In particular, this invention applies to the observation of the propellers of a ship, under the water level, and of the hydraulic flows in proximity to the propellers, from inside the structure.

Currently, the port-holes are flat glazings with parallel faces, laminated or not, made of mineral glass and/or of polymer material.

The minimum viewing angle that can be achieved is limited to 49° around the normal to the glazing. The accessible solid angle is then only 2.14 sr, i.e. 34% of the solid angle usually accessible through a glazing. It is not therefore possible to watch level with the hull, wall, etc. To observe, for example, the hydraulic flows from upstream to downstream of a propeller, it is necessary to multiply the port-holes with different positions.

The aim of the invention is to provide a port-hole of an immersed structure for seeing, from inside the structure in air, to the outside of the structure in water, level with the structure, so as to considerably reduce the constraints in positioning the port-hole over all the surface of the structure, and reduce the very number of port-holes when wanting to observe in different directions. This objective is achieved by the invention whose subject is, consequently, a port-hole of an immersed structure, for seeing, from inside the structure in air, to the outside of the structure in water, level with the structure, characterized in that the face of the port-hole oriented toward the inside of the structure comprises at least one flat section forming an angle of 20 to 40° with respect to the face of the port-hole oriented toward the outside of the structure.

The expression “immersed structure” here denotes both a structure at least partially under water and static such as an oil platform, wind turbine, and a moving structure of this type like a ship, or a submarine.

It should be noted that this outer face of the port-hole, just like each of said flat sections (also called “facets” hereinbelow) can, independently of one another, be more or less domed. The particular angle of each of the facets defining the invention is considered with respect to the section of the outer surface of the port-hole which is facing this facet, and, if one or other, or both this facet and this section of outer surface of the port-hole is (are) domed, a mean plane or rectilinear direction is defined corresponding to the domed surface or surfaces, to the circular arc or to the circular arcs considered, in order to determine the angle of the flat section with respect to the outer face of the port-hole. According to the invention, the angles of the different internal flat sections with respect to the outer face of the port-hole are different from one another.

The geometrical optic makes it possible to define these angles according to the position of the port-hole and the zone to be observed.

Since the observation is generally done by camera, one or else several, flat sections of reduced sizes (facets) with different angles is/are produced to cover a wide visual zone with a reduced number of port-holes. A camera can for example be positioned inside the boat, facing each of the facets to observe a specific part of the outside environment of the structure: hull or other wall, propeller, etc.

The number and the inclination of the facets are therefore obviously variable and selected on a per-case basis.

Preferably, said angle is at least equal to 25° on the one hand, at most equal to 35°, preferably 30° on the other hand.

Preferably, the face of the port-hole oriented toward the inside of the structure comprises at least one flat section parallel to the face of the port-hole oriented toward the outside of the structure.

According to a first variant, the port-hole of the invention comprises several said flat sections defining planes whose pairwise intersections are straight lines substantially parallel to the face of the port-hole oriented toward the outside, and parallel to one another.

According to a second variant, the port-hole of the invention comprises several said flat sections forming an angle of 20 to 40° with respect to the face of the port-hole oriented toward the outside of the structure, and conforming to a polyhedron. Forms that can be cited include a pyramid with triangular base, isosceles triangle (tetrahedron), or with square base (demi-octahedron), in which the bases are parallel to the face of the port-hole oriented toward the outside of the structure. In this variant, the face of the port-hole oriented toward the inside of the structure can comprise a flat section parallel to the face of the port-hole oriented toward the outside of the structure and forming a truncated face of said polyhedron.

Preferably, the port-hole comprises a monolithic glazing consisting of a single transparent sheet of mineral glass such as sodocalcic, aluminosilicate, borosilicate, etc., possibly thermally tempered or chemically reinforced, or of polymer material such as poly(methyl methacrylate) (PMMA), polycarbonate (PC), polyurethane (PU), ionomer resin, etc., and/or a laminated glazing consisting of several such transparent sheets of mineral glass or of polymer material glued in pairs by an adhesive interlayer of polyvinylbutyral (PVB), thermoplastic polyurethane (TPU), ethylene-vinyl acetate (EVA), etc.

Preferably, at least one of said flat sections is mounted with the face of the port-hole oriented toward the outside of the structure in double-glazing with a space filled with air or rare gas for example such as krypton, argon, xenon, in triple-glazing with two spaces filled with air or rare gas for example, or in multiple glazing with at least three spaces filled with air or rare gas for example. The double glazing, respectively the triple glazing, respectively the multiple glazing, consists of two, respectively three, respective at least four, monolithic glazings made of mineral glass or of polymer material, or laminated glazings consisting of several transparent sheets of mineral glass or of polymer material glued in pairs by an adhesive interlayer as explained previously. Two adjacent monolithic or laminated glazings in the structure of the double, triple or multiple glazing are mounted with a gap defining a space filled with air or rare gas for example. In the port-hole, each of these spaces filled with air or gas can be delimited by two main surfaces, parallel or not.

In the port-hole of the invention, at least one of said flat sections can delimit a monolithic glazing and/or at least one of said flat sections can delimit a laminated glazing and/or at least one of said flat sections can delimit a multiple glazing (including double or triple). In other words, these three glazing structures (monolithic, laminated and multiple) can coexist in a port-hole of the invention.

Preferably, the port-hole is mounted in a frame consisting of a window frame secured to (such as welded to) the mounting structure of the port-hole, a turn-up and screws, the sealing between the port-hole and the frame being obtained via a dry or extruded seal.

Another subject of the invention is the application of a port-hole as described above to a ship or a submarine, notably as propeller port-hole, or to any immersed structure or equipment such as an oil platform, wind turbine, etc. In this application, the underwater observation level with the mounting structure of the port-hole, from the inside thereof, is performed in the best conditions.

The attached drawings illustrate the invention. The figures are schematic representations in cross-section of propeller port-holes as mentioned previously.

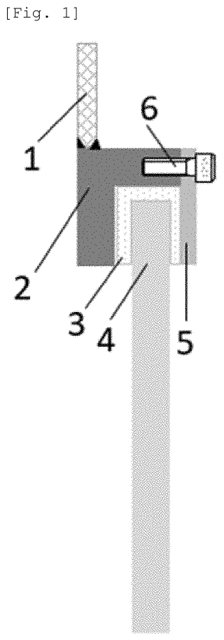

FIG. 1 is a partial view of a port-hole of the state of the art, showing its link to the hull of a boat;

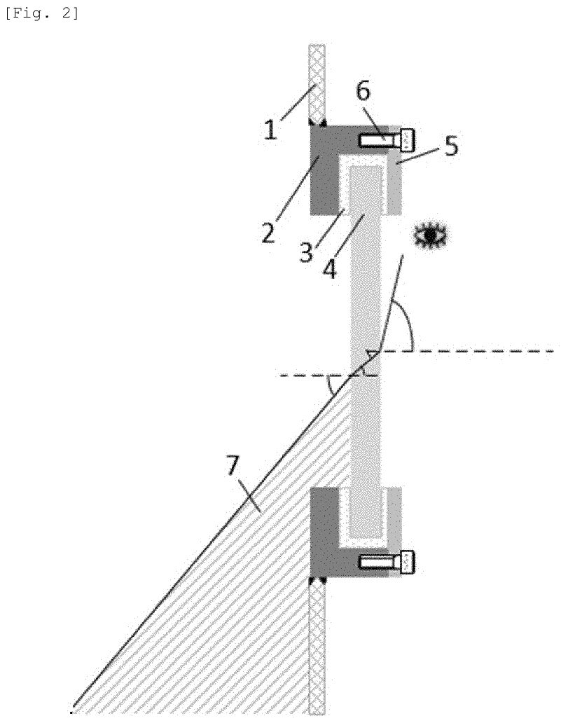

FIG. 2 is a complete view of the same port-hole showing the optical path of vision from inside the boat to the water outside the latter, through the port-hole;

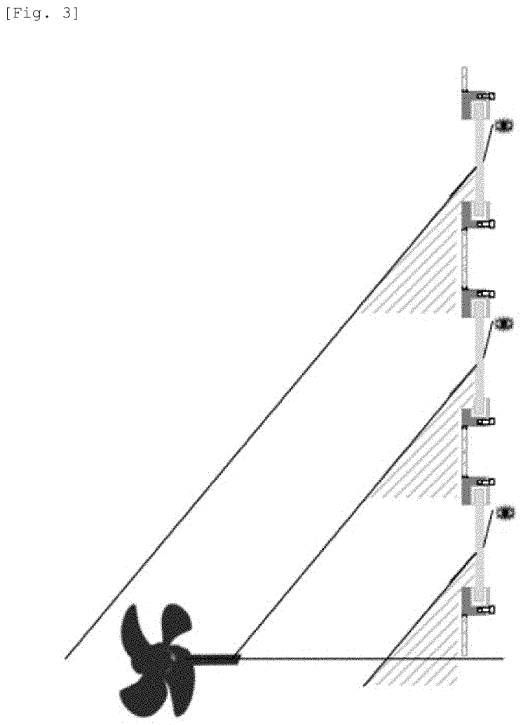

FIG. 3 represents three port-holes identical to that of FIGS. 1 and 2, distributed over the hull of the boat so as to be able to observe the hydraulic flows from upstream to downstream of the propeller;

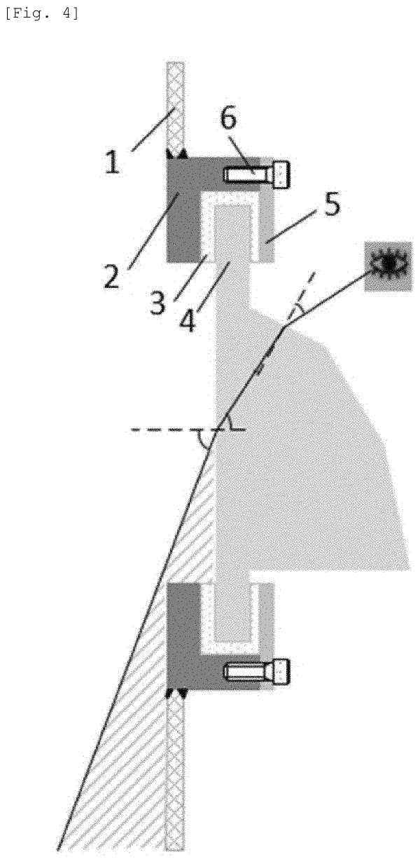

FIG. 4 is a complete view of a port-hole according to the invention, in mounting position on the hull of a boat, showing the optical path of vision from the inside of the boat to the water outside the latter, through a flat section or facet of the port-hole;

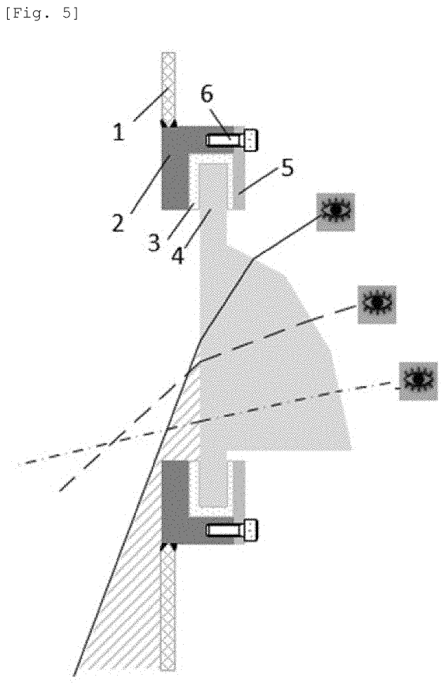

FIG. 5 is a view identical to FIG. 4, showing the optical path of vision through each of the three facets of the port-hole;

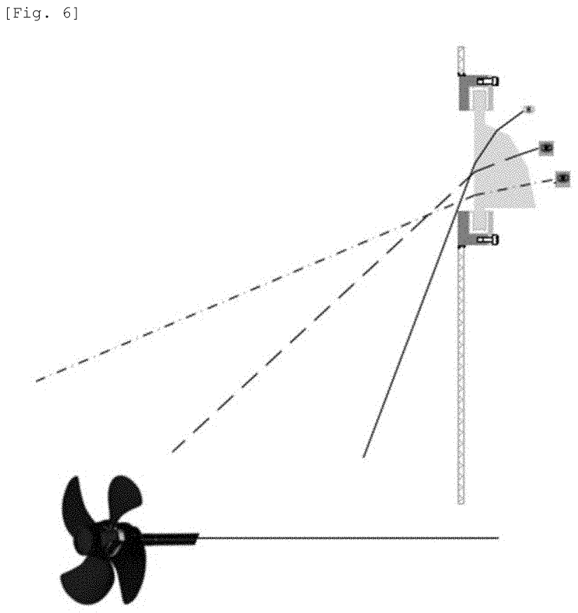

FIG. 6 is a zoomed-out view encompassing that of FIGS. 4 and 5 and the propeller of the boat; and

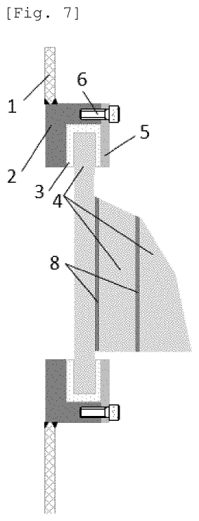

FIG. 7 is a complete view of a port-hole according to the invention in mounting position on the hull of a boat, the port-hole consisting of a laminated glazing.

Referring to FIG. 1, a port-hole 4 consists of a flat glazing with parallel faces, monolithic, made of mineral glass or polymer material or else laminated.

A mounting frame of the port-hole 4 comprises a window frame 2 welded to the hull 1 of the boat, a turn-up 5 and a screw 6, which make it possible to mount the glazing by pinching. The sealing between the glazing 4 and the frame is ensured by a dry or extruded seal 3.

Referring to FIG. 2, the optical path passes through, in succession, the air inside the boat of refractive index 1, the glass of the port-hole 4 (monolithic glazing made of sodocalcic float mineral glass) of refractive index 1.5 and the water of refractive index 1.3. The non-visible zone 7 is relatively great.

To be able to observe the hydraulic flows from upstream to downstream of the propeller, it is therefore necessary to distribute three port-holes according to the state of the art over the hull of the boat, as represented in FIG. 3. The zones that are not visible from each of the three port-holes are represented shaded. The port-holes from top to bottom make it possible to observe the hydraulic flows after the propeller, the propeller itself and the hydraulic flows before the propeller.

In FIGS. 4, 5 and 6, a port-hole 4 according to the invention is assumed, for simplicity, to be monolithic made of mineral glass, that is to say whole and integral, in one piece, obtained by any appropriate method: cutting, polishing, etc. The port-hole 4 comprises three facets defining angles that are different from one another with respect to the flat face of the port-hole 4 oriented toward the water outside the boat.

Applying the same refractive indices as those cited above, it can be seen in FIG. 4 that the zone not visible (represented shaded) to view through the top facet is much smaller than for the flat port-holes with parallel faces of the state of the art.

FIGS. 5 and 6 show how the implementation of the three facets on the internal face of the port-hole 4 makes it possible to observe the propeller and the hydraulic flows on either side thereof, from the single port-hole according to the invention.

In FIG. 7, a port-hole 4 consists of three sheets 4 of mineral glass or polymer material such as PMMA glued in pairs by an adhesive interlayer 8 of PVB or TPU. The intermediate sheet 4 is beveled so as to constitute the top facet, whereas the other two facets are obtained by complex shaping of the sheet 4 represented on the right in the figure.

According to another variant of the invention, one or several inclined faces (flat sections, facets) of the port-hole 4 can be mounted in multiple-glazing with one or more spaces filled with air or gas, with the vertical outer face of the port-hole 4.

To simplify, FIGS. 4 to 7 relating to the port-hole of the invention represent a variation of angle of said flat sections in two dimensions, that is to say illustrate the first main variant of the port-hole of the invention, in which it comprises several said flat sections defining planes whose pairwise intersections are straight lines substantially parallel to the face of the port-hole oriented toward the outside, and parallel to one another.

By convention, the flat sections of the port-hole in these figures can be designated from top to bottom by an angle with positive sign, for example to the face of the port-hole oriented toward the outside, i.e., from top to bottom, +40°, +30°, +20° for example, the figures not necessarily exactly representing these angles.

Other examples below fall within the scope of the invention.

A port-hole having a single facet of +25° angle provides, for vision from inside in air to the outside in water, a solid angle of 2.46 sr, representing 39% of the maximum solid angle of 2π sr. By comparison, the solid angle of a port-hole with parallel faces is 2.14 sr, i.e. 34%. In the device represented in FIG. 3, an equivalent vision could be obtained by eliminating the top port-hole and the bottom one, and by using, above the median port-hole, a port-hole with +25° facet, without the constraints of positioning thereof being very high. This port-hole with single +25° facet here makes it possible to use two port-holes instead of three.

A port-hole with two facets of +25° and 0° from top to bottom provides a solid angle of 3.25 sr, i.e. 52%.

A port-hole with three facets of +25°, 0° and −25° from top to bottom provides a solid angle of 4.35 sr, i.e. 69%.

According to the second main variant of the port-hole of the invention, it comprises several said flat sections forming an angle of 20 to 40° with respect to the face of the port-hole oriented toward the outside of the structure, and conforming to a polyhedron. The variations of angle of said flat sections are, here, in three dimensions.

A tetrahedron of three facets at 25° and an isosceles triangle base parallel to the face of the port-hole oriented toward the outside of the structure, provides a solid angle of 5.33 sr, i.e. 85%. The same values are obtained by truncating this tetrahedron, by adding a 0° facet.

A pyramid with square base (demi-octahedron) of four facets at 25° and a square base parallel to the face of the port-hole oriented toward the outside of the structure, provides a solid angle of 5.89 sr, i.e. 94%. The same values are obtained by truncating this tetrahedron, by adding a 0° facet.

1. A port-hole of a submerged structure, for seeing, from an inside of the structure in air, to an outside of the structure in the water, level with the structure, wherein a face of the port-hole oriented toward the inside of the structure comprises at least one flat section forming an angle of 20 to 40° with respect to the face of the port-hole oriented toward the outside of the structure.

2. The port-hole as claimed in claim 1, wherein said angle is at least equal to 25°.

3. The port-hole as claimed in claim 1, wherein said angle is at most equal to 35°.

4. The port-hole as claimed in claim 1, wherein the face of the port-hole oriented toward the inside of the structure comprises at least one flat section parallel to the face of the port-hole oriented toward the outside of the structure.

5. The port-hole as claimed in claim 1, further comprising a plurality of said flat sections defining planes whose pairwise intersections are straight lines substantially parallel to the face of the port-hole oriented toward the outside, and parallel to one another.

6. The port-hole as claimed in claim 1, further comprising a plurality of said flat sections forming an angle of 20 to 40° with respect to the face of the port-hole oriented toward the outside of the structure, and conforming to a polyhedron.

7. The port-hole as claimed in claim 6, wherein the face of the port-hole oriented toward the inside of the structure comprises a flat section parallel to the face of the port-hole oriented toward the outside of the structure and forming a truncated face of said polyhedron.

8. The port-hole as claimed in claim 1, further comprising a monolithic glazing consisting of a single transparent sheet of mineral glass, optionally thermally tempered or chemically reinforced, or of polymer material, and/or a laminated glazing consisting of several such transparent sheets of mineral glass or of polymer material glued in pairs by an adhesive interlayer of polyvinylbutyral (PVB), thermoplastic polyurethane (TPU), or ethylene vinyl acetate (EVA).

9. The port-hole as claimed in claim 1, wherein at least one of said flat sections is mounted with the face of the port-hole oriented toward the outside of the structure in double-glazing with a space filled with air or rare gas, in triple-glazing with two spaces filled with air or rare gas, or in multiple glazing with at least three spaces filled with air or rare gas.

10. The port-hole as claimed in claim 1, wherein the port-hole is mounted in a frame consisting of a window frame secured to a mounting structure of the port-hole, a turn-up and screws, the sealing between the port-hole and the frame being obtained via a dry or extruded seal.

11. A method comprising providing a port-hole according to claim 1 to a ship or a submarine or to an immersed structure or equipment.

12. The port-hole as claimed in claim 3, wherein said angle is at most equal to 30°.

13. The port-hole as claimed in claim 8, wherein the mineral glass is a sodocalcic, aluminosilicate, or borosilicate glass, and wherein the polymer material is poly(methyl methacrylate) (PMMA), polycarbonate (PC), polyurethane (PU), or ionomer resin.

14. The port-hole as claimed in claim 9, wherein the air or rare gas is krypton, argon, xenon.

15. The method as claimed in claim 11, wherein the port-hole is a propeller port-hole.

16. The method as claimed in claim 15, wherein the structure or equipment is an oil platform or wind turbine.
